(19) United States
(12) Patent Application Publication
(10) Pub. No.: US 2019/0303316 A1
(43) Pub. Date: Oct. 3, 2019

(54) HARDWARE BASED VIRTUAL MEMORY MANAGEMENT

(71) Applicant: BioNym Consulting Inc, Nepean (CA)

(72) Inventor: Maher Amer, Nepean (CA)

(21) Appl. No.: 16/368,180

(22) Filed: Mar. 28, 2019

Related U.S. Application Data
(60) Provisional application No. 62/649,362, filed on Mar. 28, 2018.

(51) Int. Cl. G06F 13/16; G06F 13/42

(52) U.S. Cl. CPC G06F 13/1684; G06F 2213/0024; G06F 13/4221

(57) ABSTRACT

Memory module, computing device, and mesh network are described. A memory module comprises at least one low latency media; a logical controller; a first hybrid bus connecting a CPU memory controller with the logic controller; and a second bus connecting a mesh network with the logic controller; and wherein the logical controller is configured to control data transmission between the low latency media and the CPU memory controller, and between the low latency media and the mesh network.

### FIELD

The present application relates to virtual memory management, specifically to a memory system containing computing devices and memory modules.

### BACKGROUND

Software based virtual memory manager (VMM) slows the operations related to memory module of a computer or a server. Sometimes, the performance of a computer and server may become unpredictable. As such, the software based VMM may become a bottleneck in applications with high volume data transfers requirements.

### SUMMARY

In an aspect, there is provided a memory module comprising at least one low latency media; a logical controller; a first hybrid bus connecting a CPU memory controller with the logic controller; and a second bus connecting a mesh network with the logic controller; and wherein the logical controller is configured to control data transmission between the low latency media and the CPU memory controller, and between the low latency media and the mesh network.

### BRIEF DESCRIPTION OF THE DRAWINGS

Reference will now be made, by way of example, to the accompanying drawings which show example embodiments of the present application, and in which:

FIG. 1 is a block diagram showing the architecture of a computing device;

FIG. 2a is a block diagram showing a memory module of the computing device of FIG. 1;

FIG. 2b is a block diagram showing a further memory module of the computing device of FIG. 1;

FIG. 3 is a block diagram showing a memory module according to an embodiment of the present disclosure;

FIG. 4 is a block diagram illustrating the structure of a computing device with the memory module of FIG. 3, according to an embodiment of the present disclosure;

FIG. 5 is a block diagram illustrating a computing device network, according to an embodiment of the present disclosure;

Similar reference numerals may have been used in different figures to denote similar components.

### DESCRIPTION OF EXAMPLE EMBODIMENTS

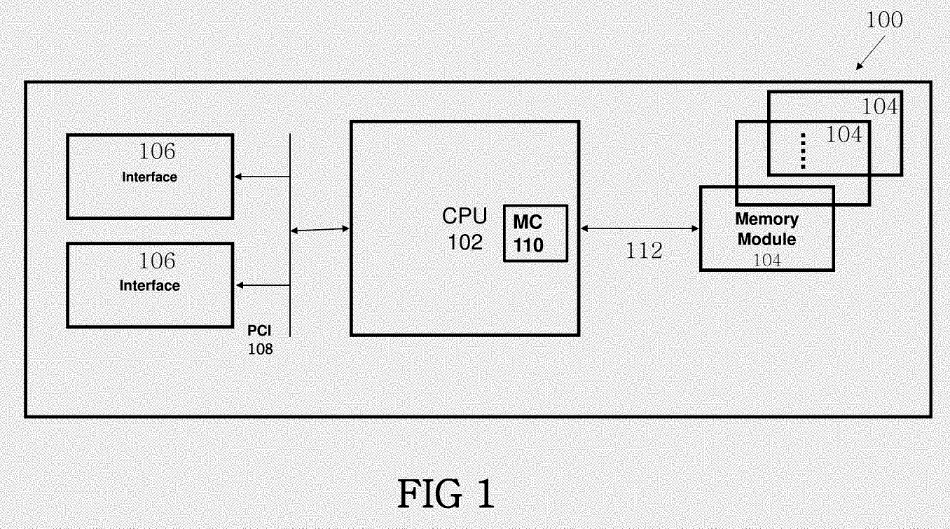

FIG. 1 illustrates a structure of a computing device 100. The computing device 100 may be any electronic device that has the computing power and memory storage capacity, for example, a computer or a server. The computing device 100 may include at least one central processing unit (CPU) 102, at least one memory module 104, and at least one interface 106.

The CPU 102 interacts with the memory module 104 and the interface 106, and carries out the instructions of a computer program by performing the arithmetic, logical, control and input/output (I/O) operations specified by the instructions. The CPU 102 includes a memory controller 110. The memory controller 110 controls the write/read operation of the data on the memory module 104.

The memory module 104 executes write and read operations of the computing device 100. The memory module 104 includes dual in-line memory modules (DIMM) and non-volatile dual in-line memory modules (NVDIMMs). The memory modules 104 include consistent low latency media, such as dynamic random-access memory (DRAM). Memory media are typically directly plugged onto the memory bus of the memory modules 104. All data transfers to and from the memory module 104 must go through the memory controller 110 in the CPU 102.

A DIMM is a standard module defined by the Joint Electron Device Engineering Council (JEDEC). A DIMM plugs into memory bus sockets (DIMM socket) of the computing device 100. DIMM uses dual data rate (DDR) protocol to execute write/read operations. Up until DDR4 generation, the only standard memory media that can be mounted on standard DIMM is DRAM because of its low and consistent latency, which is a requirement for all DDR protocols so far. However, DRAMs are expensive, not dense, and volatile, Flash, RRAM are examples of commercially available new persistent, denser, and potentially cheaper storage media. All new storage media to be able to be plugged directly in the memory bus 112, on the other hand, suffer high and/or inconsistent latency.

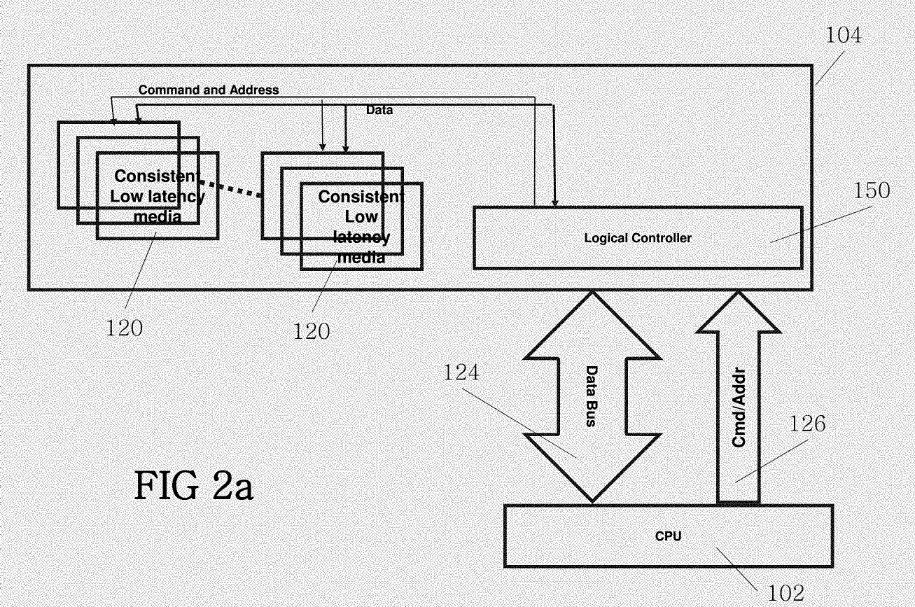

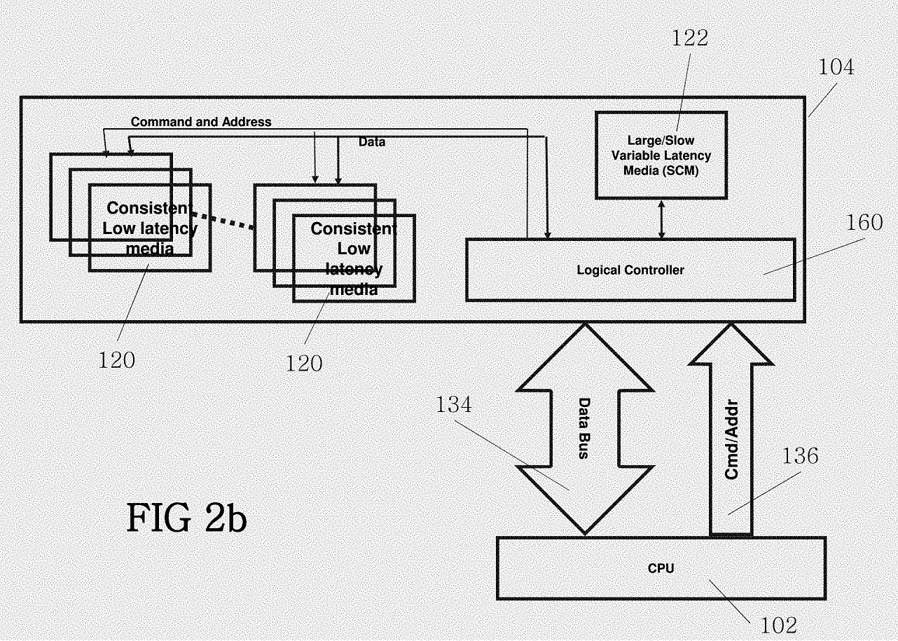

The memory module 104 illustrated in FIG. 2a is a DIMM. In FIG. 2a, the DIMM includes a plurality of consistent low latency media 120, and one or more logical controllers 150. A DIMM is configured to work with only consistent and low latency memory media 120, such as DRAM. The logical controller 150 may be a command and address controller. The logical controller 150 is hardware-based. For example, the logical controller 150 may be a chip. The DIMM is connected with the CPU 102 with a fixed latency DDR data bus 124 for carrying bidirectional data between the CPU 102 and the logical controller 150. The DIMM is connected with the a memory controller 110 of the CPU 102 with a DDR bus, for example, a command address bus 126 for carrying command or address from the CPU 102 to the logical controller 150. The logical controller 150 receives command and address from the CPU 102 via the command address bus 126, and receives and sends data on fixed latency DDR data bus 124 to the CPU 102 based on the received command and address. When the CPU 102 needs to read from or write to the DIMM, the memory controller 110 in the CPU 102 uses the command and address bus 126 to specify the physical address of the individual memory block of DRAM to be accessed, while the actual data to and from the DIMM is sent along the data bus 124. In a write operation, the memory controller 110 in the CPU 102 will put the data to be written to the memory media 120 associated with DIMM onto the data bus 124. In a read operation, the logical controller 150 retrieves the data from the specific memory block based on the address received and put the data onto the data bus 124.

The JEDEC is currently defining NVDIMM-P. The memory module 104 illustrated in FIG. 2b is an example configuration of NVDIMM-p. In FIG. 2b, NVDIMM-P includes a plurality of consistent low latency media 120, such as DRAM, a plurality of large or slow variable latency media, such as flash and RRAM, and a logical controller 160. The logical controller 160 of a NVDIMM-p may be a NVDIMM-P controller, which is configured to work with not only consistent low latency media 120, such as DRAM, but also large or slow variable latency media 122, such as flash and RRAM. NVDIMM-P allows slow media 122 with variable latency to be plugged directly onto the memory bus. The logical controller 160 moves data back and forth between slow media 122 and fast media 120. The NVDIMM-P is connected with the memory controller 110 in the CPU 102 with a DDR bus, such as a variable latency DDR data bus 134 and a command address bus 136. The variable latency DDR data bus 134 carries bidirectional data between the logical controller 160 and the memory controller 110 in the CPU 102, The command address bus 136 carries command or address from the memory controller 110 to the logical controller 160, Similar to the write/read operations in DIMM, in NVDIMM-P, the data can be read from or written to the consistent and low latency memory media 120 or slow variable latency media 122 via the logical controller 110. The definition of NVDIMM-P allows variable latency devices to be plugged directly on the memory bus. It also allows for out-of-order execution of memory transactions.

Referring to FIG. 1, interface 106 refers to a protocol that defines how data is transferred from one storage media to another, Examples of the interfaces include peripheral component interconnect (PCI) interface, storage interface such as Non-volatile memory express (NVMe) or serial attached small computer system interface (SAS) interface, network interfaces such as Ethernet interface, etc.

Different interfaces 106 have different characteristics. For example, a DDR memory interface is a synchronous interface and can only be deployed as master slave topology. On the other hand, a PCI interface is an asynchronous interface and is deployed as distributed topology.

Synchronous interface is a protocol where the requester of data transfer expects the operation, such as read/write operation, to complete within a predetermined and fixed time duration between the request start time and the completion time of the request. In a synchronous interface, no interrupt or polling is allowed to determine when the operation is completed. In an example of read/write operation of DDR memory interface, the timing of the electrical data and clock signals is strictly controlled to reach the required timing accuracy. Synchronous interfaces, such as DDR memory interfaces, typically have low latency in operations and as such are commonly used for applications requiring low latency in data transfer. However, storage media with low and consistent latency, such as dynamic random-access memory (DRAM), is difficult and expensive to manufacture.

On the other hand, an asynchronous interface, such as a PCI interface, is a protocol where the requester of data transfer expects an acknowledgment signal from the target indicating the completion of the transaction. The duration from sending a request to the acknowledgement that the request is completed may be varied from different requests. In the example of a PCI interface, interrupt or polling is required to determine when the operation is complete. Asynchronous interfaces, such as PCI interfaces are commonly used for large and variable rate data transfers.

Hybrid bus or interface may support synchronous and asynchronous interfaces at the same time. NVDIMM-P is an example of such interface since Memory Controller 110 communicates synchronously with fast media 120 and asynchronously with slow and variable latency media 122. on the same DDR bus 134 and 136.

As well, the master/slave topology, such as a topology of hub and spoke, is an arrangement where all data transfers between members (spoke) of the topology go through the single master (hub). In the example of DDR memory interface, the DDR memory can only be deployed as master/slave topology where all data transfers go through the memory controller 110 in the CPU 102. In other words, the memory controller 110 in the CPU serves as a hub and controls the data transfers between different memory media 104 of a the DDR memory. Via the memory controller 110, the data are synchronously transferred from a first memory medium of the memory module 104 to a second memory medium of the memory module 104 within the computing device 100 or between the computing device 100 and other memory module 104 of a different computing device 100.

Distributed topology, such as a topology of a mesh network, is an arrangement where all members of the topology are able to communicate directly with each other, PCI interface can be deployed as distributed topology as a mesh network topology. The PCI interface allows the elements connected to a PCI bus transfer data directly with each other in an asynchronous manner. DRAM are currently the only storage media that can have consistent and low latency for use in the memory module 104. DRAM is a type of random access semiconductor memory that stores each bit of data in a separate capacitor within an integrated circuit. However, DRAMs are expensive and are low in density.

Applications of the computing device 100 run off data that is stored in DRAM, the system memory of the computing device 100. In order for multiple applications to run on the same system memory of the computing device 100, a virtual memory manager (VMM), which is a software running as part of the Operating System of the computing devices 100, allocates virtual memory dedicated to each application. The VMM manages a mapping between applications virtual memory and actual physical memory. The VMM services memory allocation requests from applications, maps virtual memory of the applications to the physical memory of the computing device 100. As well, by means of Page Fault Handling, the VMM manages physical memory overflow. For example, if the computing device 100 runs out of physical memory, some data must move from the physical memory DRAM to storage media and this is also known as Swap.

As VMM is software based, it is very flexible to implement. On the other hand, software based VMM makes the operations related to memory module 104 slow, and the performance of the computing device 100 may become unpredictable. As such, the software based VMM may become a bottleneck of the computing device 100 in data transfer for applications with high volume data transfers requirements.

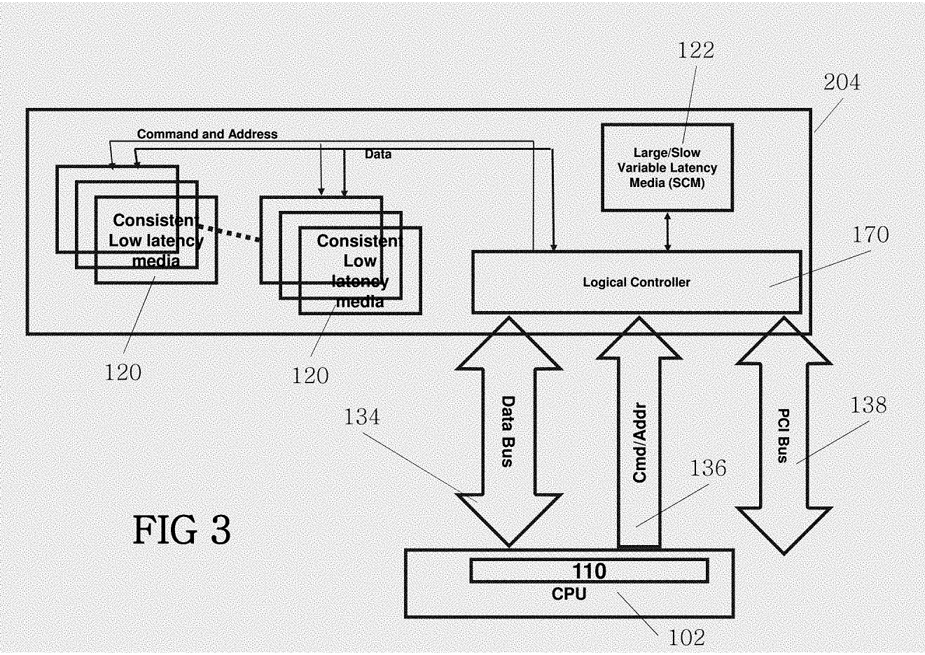

FIG. 3 illustrate an exemplary embodiment of a memory module 204, The memory module 204 is the same as the memory module NVDIMM-P described above, except that the memory module 204 further includes a PCI bus to connect the logical controller 170 with a mesh network, such as a PCI interface, without using the memory controller 110 in the CPU 102. As such, the memory module 204 retains the functions of the memory module NVDIMM-P described above. Via the mesh network, such as a PCI interface, the memory modules 204 and/or the memory media of the memory module 204 are able to communicate directly with each other. By using the mesh network, such as a PCI interface, in transferring data via a PCI bus with other PCI interfaces directly or indirectly connected with the mesh network, or other mesh networks directly or indirectly connected with the mesh network, or network elements of a mesh network that is directly or indirectly connected with the mesh network, the memory module 204 can directly move data to and from other DIMMs or other network elements of another mesh network that is directly or indirectly connected with the mesh network without the involvement of the memory controller 110 of the CPU 102. In other words, by connecting the logical controller 170 of NVDIMM-P to a PCI bus, the memory module 204, such as NVDIMM-P, can move data bi-directionally between the memory modules 204 in accordance with the PCI interface protocol, without the involvement of the CPU 102 or the operating system or the software based VMM.

The memory modules 204 does not require any modification to CPU 102, memory controller 110, operation system and Applications.

Memory modules 204 allows direct communication amongst all NVDIMM-P modules (No CPU or OS involvement); direct communication between NVDIMM-P modules and local, as well as, remote storage or compute devices; hardware accelerated data placement and prediction algorithms to maximize over all solution cost/performance metric; full Hardware only memory abstraction layer; and fully distributed memory management.

As such, the structure of the memory module 204 allows direct communication amongst all NVDIMM-P modules via PCI bus with PCI interface, without using the memory controller 110 in the CPU 102 or using the operation system such as VMM, of a computing device.

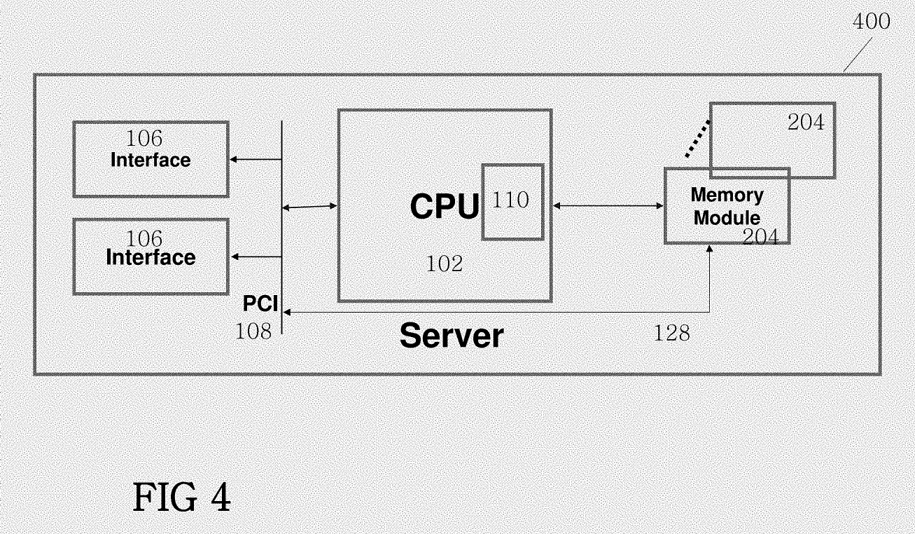

As well, in the example illustrated in FIG. 4, the memory module 204 allows direct communication between local NVDIMM-P modules within a computing device 400 via the PCI interface. In FIG. 4, the memory modules 204 directly communicate with other PCI interfaces with a PCI bus 128, such as network interface or a storage interface, without involving the CPU 102 or VMM software based operating system of the computing device 400.

In the example illustrated in FIG. 4, one or more of the Interfaces 106 can make requests to memory modules 204 to transfer data amongst memory modules 204, or amongst any one of the memory modules 204 and any Interface 106 directly or indirectly connected to the PCI bus 108. In this case, Interface 106 may act as a HW based VMM.

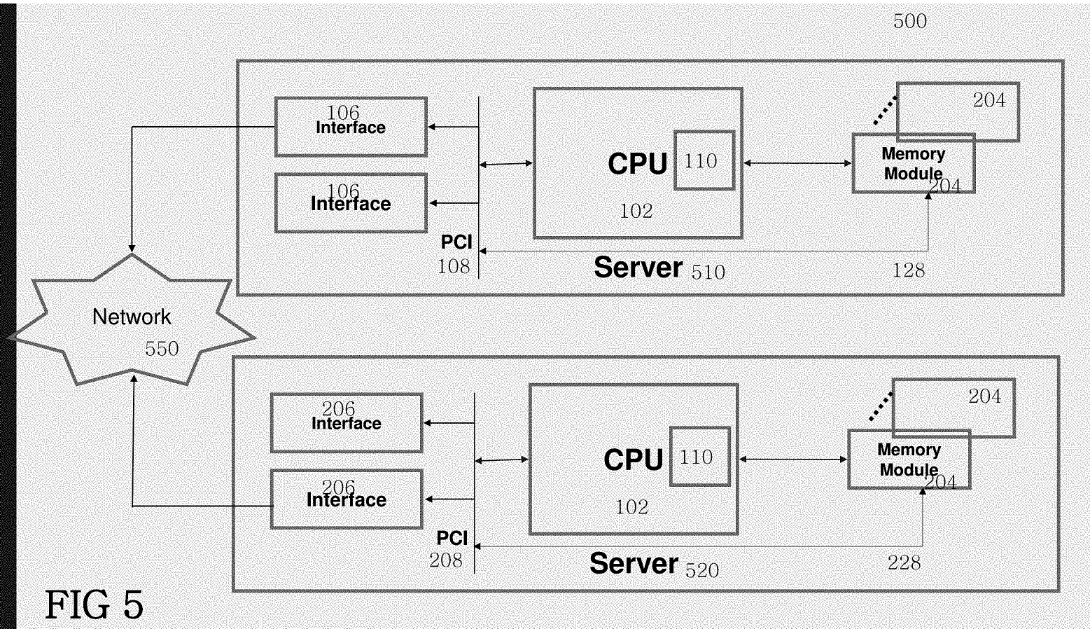

In the example of FIG. 5, the system 500 includes a first computing device 510 and a second computing device 520. Both computing devices 510 and 520 are interconnected via a network 550. The memory modules 204 in computing device 510 directly communicates with the remote memory modules 204 in computing device 520 via a PCI bus 128, and network interface 106, the network 550, to the network interface 206, the PCI bus 228 in the computing device 520, without involving the CPU 102 and the VMM operating system in both computing devices 510 and 520.

The memory module 204 therefore has full hardware only memory abstraction layer by using the PCI bus and PCI interface instead of software based VMM. The memory module 204 also has fully distributed memory management according to PCI interface protocol. Accordingly, the memory module 204, and the computing device 400 with the memory module 204 allows hardware accelerated data placement and prediction algorithms to maximize over all solution cost/performance metric.

Certain adaptations and modifications of the described embodiments can be made. Therefore, the above discussed embodiments are considered to be illustrative and not restrictive.

1. A memory module comprising:
at least one low latency media;
a logical controller;
a first hybrid bus connecting a CPU memory controller with the logic controller; and
a second bus connecting a mesh network with the logic controller; and
wherein the logical controller is configured to control data transmission between the low latency media and the CPU memory controller, and between the low latency media and the mesh network.

2. The memory module of claim 1, wherein the mesh network is a peripheral component interconnect (PCI) interface.

3. The memory module of claim 1, wherein the memory module further comprises a slow variable latency media, and wherein the logical controller is configured to control data transmission between the slow variable latency media and the CPU memory controller, and between slow variable latency media and the mesh network, and between the slow variable latency media and the at least one low latency media.

4. The memory module of claim 1, wherein the logical controller is configured to control communications between the memory module and one or more network elements directly or indirectly connected to the mesh network.

5. The memory module of claim 1, wherein the logical controller is configured to service communication requests between the memory module and one or more interfaces directly or indirectly connected to the mesh network.

6. A computing device, comprising:
a mesh network;
a memory module comprising:
at least one low latency media;
a logical controller;
a first hybrid bus connecting a CPU memory controller with the logic controller;
a second bus connecting the mesh network with the logic controller; and
wherein the logical controller is configured to control data transmission between the low latency media and the CPU memory controller, and between the low latency media and the mesh network.

7. The computing device of claim 6, comprising a first virtual memory manager (VMM) running as part of the Operating System of the computing device, and a second VMM running on a hardware based logical controller of said memory module.

8. The computing device of claim 6, comprising a first virtual memory manager (VMM) running as part of the Operating System of the computing device, and a second VMM running on an interface directly or indirectly connected to the mesh network of the computing device.

9. A mesh network comprising:
a computing device;
a memory module comprising:
at least one low latency media;
a logical controller;
a first hybrid bus connecting a CPU memory controller with the logic controller;
a second bus connecting the mesh network with the logic controller; and
wherein the logical controller is configured to control data transmission between the low latency media and the CPU memory controller, and between the low latency media and the mesh network.

10. The computing device of claim 6, wherein the mesh network is a peripheral component interconnect (PCI) interface.

11. The computing device of claim 6, wherein the memory module further comprises a slow variable latency media, and wherein the logical controller is configured to control data transmission between the slow variable latency media and the CPU memory controller, and between slow variable latency media and the mesh network, and between the slow variable latency media and the at least one low latency media.

12. The computing device of claim 6, wherein the logical controller is configured to control communications between the memory module and one or more network elements directly or indirectly connected to the mesh network.

13. The computing device of claim 6, wherein the logical controller is configured to service communication requests between the memory module and one or more interfaces directly or indirectly connected to the mesh network.

14. A mesh network comprising:
a computing device;
a memory module comprising:
at least one low latency media;
a logical controller;
a first hybrid bus connecting a CPU memory controller with the logic controller;
a second bus connecting the mesh network with the logic controller;
wherein the logical controller is configured to control data transmission between the low latency media and the CPU memory controller, and between the low latency media and the mesh network; and
a first virtual memory manager (VMM) running as part of the Operating System of the computing device, and a second VMM running on a hardware based logical controller of said memory module.

15. A mesh network comprising:
a computing device;
a memory module comprising:
at least one low latency media;
a logical controller;
a first hybrid bus connecting a CPU memory controller with the logic controller;
a second bus connecting the mesh network with the logic controller;
wherein the logical controller is configured to control data transmission between the low latency media and the CPU memory controller, and between the low latency media and the mesh network; and
a first virtual memory manager (VMM) running as part of the Operating System of the computing device, and a second VMM running on an interface directly or indirectly connected to the mesh network of the computing device.
